(19) United States
(12) Patent Application Publication
(10) Pub. No.: US 2020/0122619 A1
(43) Pub. Date: Apr. 23, 2020

(54) VEHICLE SEAT

(71) Applicants: TACHI-S CO., LTD., Tokyo (JP); CLARION CO., LTD., Saitama (JP)

(72) Inventors: Tsutomu FUJIKAKE, Tokyo (JP); Kazuo NOGUCHI, Tokyo (JP); Daisuke FUJITA, Tokyo (JP); Naoki TAKADA, Saitama (JP); Kenji KONO, Saitama (JP); Masao KOMADA, Saitama (JP); Yosuke TAKANO, Saitama (JP)

(73) Assignees: TACHI-S CO., LTD., Tokyo (JP); CLARION CO., LTD., Saitama (JP)

(21) Appl. No.: 16/655,780

(22) Filed: Oct. 17, 2019

(30) Foreign Application Priority Data
Oct. 18, 2018 (JP) 2018-196978
Oct. 18, 2018 (JP) 2018-196979

(51) Int. Cl. B60N 2/90; A47C 7/18; A47C 7/72; A61H 23/00

(52) U.S. Cl. CPC B60N 2/976; A47C 7/185; A61H 2203/0425; A61H 23/00; A47C 7/72

(57) ABSTRACT

A vehicle seat includes: a cushion pad; a vibration transmission member which has a wire shape and is embedded in the cushion pad; and a vibration device configured to vibrate the vibration transmission member. The vibration transmission member includes: a bent portion; an operation portion provided on one end side with respect to the bent portion and extending in a first direction along a seated person support surface of the cushion pad; and an input portion provided on the other end side with respect to the bent portion and extending in a second direction intersecting the seated person support surface. The vibration device vibrates the input portion in a third direction intersecting the second direction in a plane defined by the first direction and the second direction.

### CROSS-REFERENCE TO RELATED APPLICATION(S)

This application is based upon and claims the benefit of priority from Japanese Patent Application No. 2018-196978, filed on Oct. 18, 2018, and Japanese Patent Application No. 2018-196979, filed on Oct. 18, 2018, the entire contents of which are incorporated herein by reference.

### BACKGROUND

### 1. Field of the Invention

The present invention relates to a vehicle seat.

### 2. Description of the Related Art

In a vehicle seat (hereinafter, simply referred to as a seat) mounted on a vehicle such as an automobile, a seat where a vibration device (vibrator) is arranged between a cushion pad and a trim cover which covers the cushion pad and information such as lane departure and obstacle approach is sent to a seated person by vibration has been known. In order to reduce the feeling of irritation given to a seated person by the vibration device, there is also a seat in which a vibration transmission member vibrated by the vibration device is embedded in the cushion pad (see JP-A-2017-65643, for example).

In the seat described in JP-A-2017-65643, the vibration transmission member embedded in the cushion pad extends along a seated person support surface of the cushion pad from a rear end portion to a front end portion side of the cushion pad. In the rear end portion of the vibration transmission member arranged in the rear end portion of the cushion pad, a plate fixing portion is formed by bending the vibration transmission member in an L shape in a seat width direction and a plate is welded to the plate fixing portion over the entire length of the plate fixing portion including a bent portion. A speaker which is a vibration device is attached to the plate. A bending portion formed by bending the vibration transmission member into a C shape along the seated person support surface of the cushion pad is formed in the front end portion of the vibration transmission member.

In the vehicle seat described in JP-A-2017-65643, the vibration of an intermediate portion extending in a front-rear direction between the plate fixing portion and a bending portion of the vibration transmission member is transmitted to a seated person. The speaker which is a vibration device vibrates the plate fixing portion including the bent portion which is a connection portion between the plate fixing portion and the intermediate portion and the intermediate portion mainly vibrates in the front-rear direction. That is, the intermediate portion vibrates along the seated person support surface of the cushion pad, and thus, depending on the seated person, the vibration of the intermediate portion may be difficult to perceive.

Further, in the vehicle seat described in JP-A-2017-65643, the bending portion of the vibration transmission member is bent in a C shape along the seated person support surface of the cushion pad and a part of the bending portion is arranged to protrude in a seat width direction with respect to an intermediate portion. Therefore, a bending portion becomes resistance with respect to the vibration in a front-rear direction of the intermediate part, and thus there is a possibility that vibration may be attenuated. Since the vibration is attenuated, the vibration at the intermediate portion may not be perceived easily.

### SUMMARY

The invention has been made in view of the circumstances described above and an object thereof is to provide a vehicle seat which can finely transmit vibration to a seated person.

According to an aspect of the invention, there is provided a vehicle seat, including: a cushion pad; a vibration transmission member which has a wire shape and is embedded in the cushion pad; and a vibration device configured to vibrate the vibration transmission member, wherein: the vibration transmission member includes: a bent portion; an operation portion provided on one end side with respect to the bent portion and extending in a first direction along a seated person support surface of the cushion pad; and an input portion provided on the other end side with respect to the bent portion and extending in a second direction intersecting the seated person support surface; and the vibration device vibrates the input portion in a third direction intersecting the second direction in a plane defined by the first direction and the second direction.

According to another aspect of the invention, there is provided a vehicle seat, including: a cushion pad; a vibration transmission member which has a wire shape and is embedded in the cushion pad; and a vibration device configured to vibrate the vibration transmission member, wherein: the vibration transmission member includes an operation portion which extends along a seated person support surface of the cushion pad and vibrates in a direction intersecting the seated person support surface; and a tip end portion of the operation portion is bent in a vibration direction of the operation portion and in a direction away from the seated person support surface.

According to the invention, a vehicle seat which can finely transmit a vibration to a seated person can be provided.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view illustrating an example of a vehicle seat for explaining an embodiment of the invention;

FIG. 2 is an exploded perspective view of a vibration generating device provided in the vehicle seat of FIG. 1;

FIG. 3 is a side view of the vibration generating device in FIG. 2;

FIG. 4 is a rear view of the vibration generating device in FIG. 2;

FIG. 5 is a perspective view of another example of the vibration generating device for explaining an embodiment of the invention;

FIG. 6 is a side view of the vibration generating device in FIG. 5;

FIG. 7 is a side view of a modification example of the vibration generating device in FIG. 5;

FIG. 8 is a perspective view of another modification example of the vibration generating device in FIG. 5;

FIG. 9 is an enlarged side view illustrating a tip end portion of a vibration transmission member of the vibration generating device of FIG. 3;

FIG. 10 is a front view of the vibration generating device of FIG. 3;

FIG. 11 is a side view of a modification example of the tip end portion of the vibration transmission member of FIG. 9;

FIG. 12 is a side view of another modification example of the tip end portion of the vibration transmission member of FIG. 9;

FIG. 13 is an enlarged view of still another modification example of the tip end portion of the vibration transmission member of FIG. 9;

FIG. 14 is an enlarged view of still another modification example of the tip end portion of the vibration transmission member of FIG. 9;

FIG. 15 is an enlarged view of still another modification example of the tip end portion of the vibration transmission member of FIG. 3;

FIG. 16 is a view of a modification example of the vibration transmission member of FIG. 9; and

FIG. 17 is a plan view of a modification example of the vehicle seat of FIG. 1.

### DETAILED DESCRIPTION OF THE INVENTION

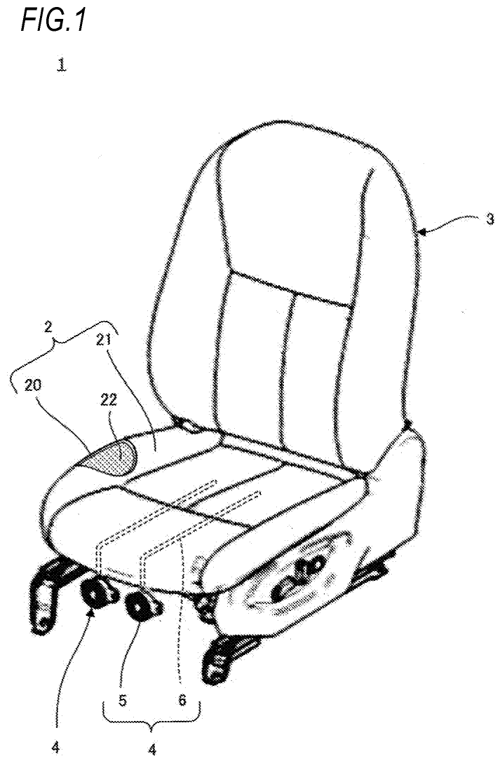

FIG. 1 is a perspective view of an example of a vehicle seat for explaining an embodiment of the invention.

A vehicle seat 1 (hereinafter also simply referred to as a seat) illustrated in FIG. 1 is a seat installed in a vehicle such as an automobile and includes a seat cushion 2 which supports the buttocks and thighs of an occupant (hereinafter referred to as a seated person) seated in the seat 1, a seat back 3 which supports the waist and back of the seated person, and one or more (two in the present example) vibration generating devices 4 and 4.

The seat cushion 2 includes a cushion pad 20 made of a foam material such as urethane foam and a trim cover 21 which covers the cushion pad 20. A seated person support surface 22 of the cushion pad 20 is an upper surface of the cushion pad 20 which is in contact with the buttocks and thighs of the seated person via the trim cover 21. The seat back 3 also includes a cushion pad made of a foam material such as urethane foam and a trim cover which covers the cushion pad. A seated person support surface of the cushion pad of the seat back 3 is a front surface of the cushion pad which is in contact with the waist and back of the seated person via the trim cover.

In the present example, two vibration generating devices 4 and 4 are installed in a center of a seat width direction of the seat cushion 2 and one vibration generating device 4 generates vibration alone or two vibration generating devices 4 and 4 cooperate to generate vibration. When the vibration generated by the vibration generating device 4 is perceived by the seated person, various information is transmitted to the seated person.

The vibration generating device 4 includes a vibration device 5 and a vibration transmission member 6 which is vibrated by the vibration device 5.

The vibration transmission member 6 is a wire-like member and one end portion of the vibration transmission member 6 is connected to the vibration device 5. Each vibration transmitting members 6 of the two vibration generating devices 4 are embedded in the cushion pad 20 to be separated from each other in a seat width direction and extend in a seat front-rear direction as a whole. Since the vibration transmission member 6 is embedded in the cushion pad 20, for example, compared to a case where the vibration transmission member 6 is installed between the cushion pad 20 and the trim cover 21 to be in contact with the trim cover 21, the irritation given to the seated person is reduced. The vibration device 5 may be embedded in the cushion pad 20, may be provided between the cushion pad 20 and the trim cover 21, or may be provided exposed from the trim cover 21.

As a vibrator 14 (described below) of the vibration device 5, for example, an exciter described in JP-A-2017-19386 can be used. An exciter is constituted such that a voice coil is arranged in a magnetic circuit formed by a permanent magnet and a yoke. In the exciter, when an AC signal is supplied to the voice coil, the voice coil and a voice coil bobbin which supports the voice coil vibrate at a frequency corresponding to the AC signal. The vibration is transmitted to the vibration transmission member 6. According to the exciter, it is possible to appropriately change a vibration location of the vibration transmission member 6 according to the frequency of the AC signal supplied to the voice coil and it is possible to transmit various information to the seated person.

The material of the vibration transmission member 6 may be any material which can easily transmit the vibration generated by the vibration device 5 and is a metal material such as iron, steel, aluminum, magnesium, spring steel, or an alloy thereof. The material of the vibration transmission member 6 may be resin material such as fiber reinforced plastic. The material of the vibration transmission member 6 is appropriately selected based on various viewpoints such as formability, weight reduction, and resonance point adjustment. The cross-sectional shape of the vibration transmission member 6 may be a polygonal shape such as a triangular shape or a quadrangular shape, but is preferably a circular shape from the viewpoint of reducing the feeling of irritation given to the seated person.

The seat 1 in which the two vibration generating devices 4 and 4 are spaced apart in a seat width direction and provided in the seat cushion 2 can be used, for example, in a lane departure prevention support system. The lane departure prevention support system recognizes a lane based on an image in front of the vehicle and issues a warning to notify the occupant if the vehicle deviates from or is about to deviate from the lane without the direction indicator of the vehicle being operated.

The front of the vehicle is imaged by a camera mounted on a vehicle and the obtained image data is transmitted to an electronic control unit (ECU) mounted on the vehicle. The ECU recognizes the lane from the image data using a known image recognition technique and determines whether or not the vehicle deviates from or is about to deviate from the lane. When the vehicle deviates from or is about to deviate from the lane, the ECU determines whether the vehicle deviates from or is about to deviate from the lane to the left or the vehicle deviates from or is about to deviate from the lane to the right.

When it is determined that the vehicle deviates or is about to deviate from the lane to the left, the ECU operates the vibration device 5 of the left vibration generating device 4 of the two vibration generation devices 4 provided in the seat cushion 2. As a result, vibration is transmitted to the left side of the seated person's body and the seated person's attention is alerted to lane departure to the left side. On the other hand, when it is determined that the vehicle deviates or is about to deviate from the lane to the right, the ECU operates the vibration device 5 of the right vibration generating device 4 of the two vibration generation devices 4 provided in the seat cushion 2. Thereby, vibration is transmitted to the right side of the seated person's body and the seated person's attention is alerted to the lane departure to the right side.

The seat 1 can also be used for a system for notifying the occupant of the approach of obstacles (such as other vehicles) on the front, rear, left, and right of the vehicle, a system for preventing the occupant from falling asleep, or the like. The number and arrangement of the vibration generating devices 4 are appropriately set according to the application. For example, when seat 1 is used in a system which prevents an occupant from falling asleep, the number of vibration generating devices 4 may be one. One or more vibration generating devices 4 may be provided in the seat back 3. The vibration generating device 4 provided in the seat back 3 can be configured in the same manner as the vibration generation device 4 provided in the seat cushion 2 except that the vibration transmission member 6 extends in a seat vertical direction as a whole.

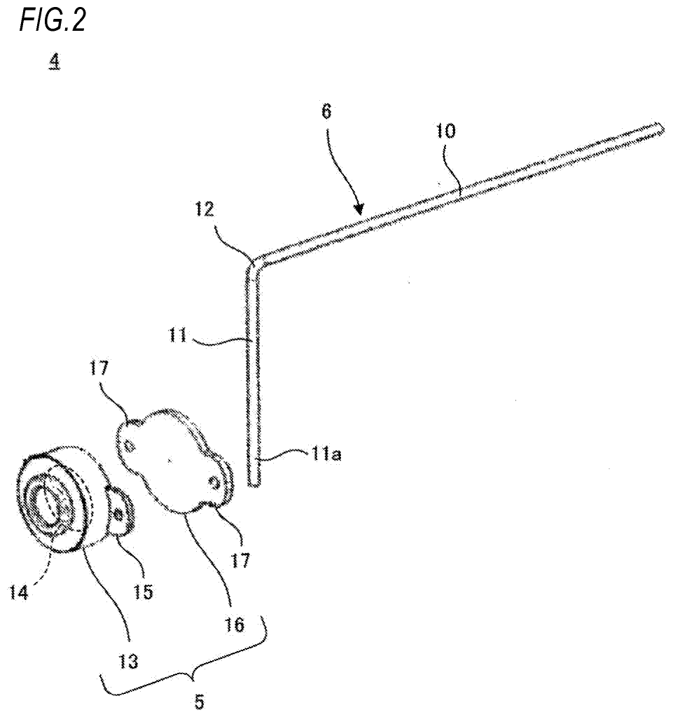

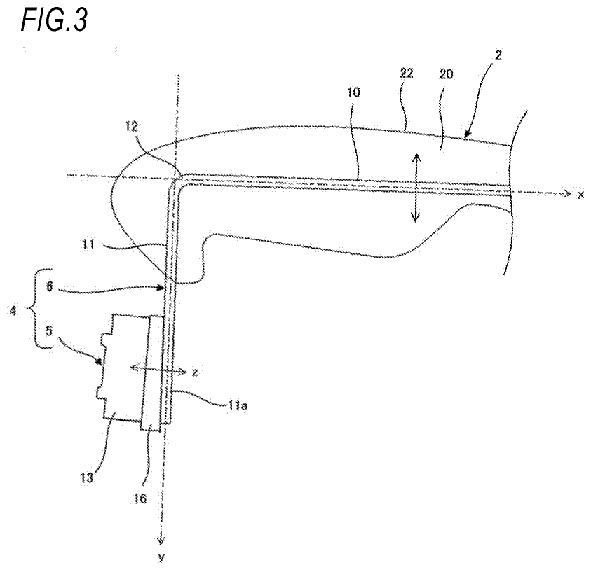

FIGS. 2 and 3 illustrate the configuration of the vibration generating device 4.

As illustrated in FIGS. 2 and 3, the vibration transmission member 6 includes an operation portion 10 which transmits vibration to a seated person, an input portion 11 which is vibrated by the vibration device 5, and a bent portion 12 which is interposed between the operation portion 10 and the input portion 11. The bent portion 12 is formed by bending an intermediate portion in a length direction of the vibration transmission member 6 at a substantially right angle. In the bent portion 12, one end portion side of the vibration transmission member 6 across the bent portion 12 is provided as the operation portion 10 and the other end portion side of the vibration transmission member 6 is provided as the input portion 11. The operation portion 10, the input portion 11, and the bent portion 12 are integrally formed. The operation portion 10 is disposed along the seated person support surface 22 of the cushion pad 20 to extend in the seat front-rear direction (first direction x). On the other hand, the input portion 11 is disposed to extend in the seat vertical direction (second direction y) intersecting the seated person support surface 22.

The vibration device 5 includes a main body 13 including the vibrator 14 and a bracket 16. The bracket 16 is joined to an end portion 11a of the input portion 11 opposite to the bent portion 12 side and is appropriately spaced from the bent portion 12. The main body 13 includes a pair of tab pieces 15 and the bracket 16 also includes a pair of tab pieces 17. The tab piece 15 is overlapped with the tab piece 17 and the overlapped tab pieces 15 and 17 are fastened by a fastener such as a screw or a rivet. Thereby, the main body 13 is fixed to the bracket 16 and attached to the input portion 11 via the bracket 16.

As illustrated in FIG. 3, the main body 13 of the vibration device 5 vibrates the end portion 11a of the input portion 11 via the bracket 16 in the seat front-rear direction substantially parallel to an extending direction (first direction x) of the operation portion 10. An excitation direction (third direction z) is not limited to a direction substantially parallel to the extending direction (first direction x) of the operation portion 10. The excitation direction may be any direction which intersects the extending direction (second direction y) of the input portion 11, in a plane defined by the extending direction (first direction x) of the operation portion 10 and the extending direction (second direction y) of the input portion 11.

The vibration input to the end portion 11a of the input portion 11 propagates to the operation portion 10 via the bent portion 12. Here, the vibration transmission member 6 is not a perfect rigid body. As the end portion 11a of the input portion 11 is appropriately separated from the bent portion 12, the vibration input to the end portion 11a is converted from the vibration in the seat front-rear direction to the vibration in the seat vertical direction based on the bending of the vibration transmission member 6 in the bent portion 12, and then the converted vibration is propagates to the operation portion 10. The vibration output from the operation portion 10 is vibration in a seat vertical direction substantially perpendicular to the seated person support surface 22 of the cushion pad 20 and the vibration in the seat vertical direction is more perceptible to the seated person than the vibration in the seat front-rear direction along the seated person support surface 22. As a result, vibration can be finely transmitted to the seated person.

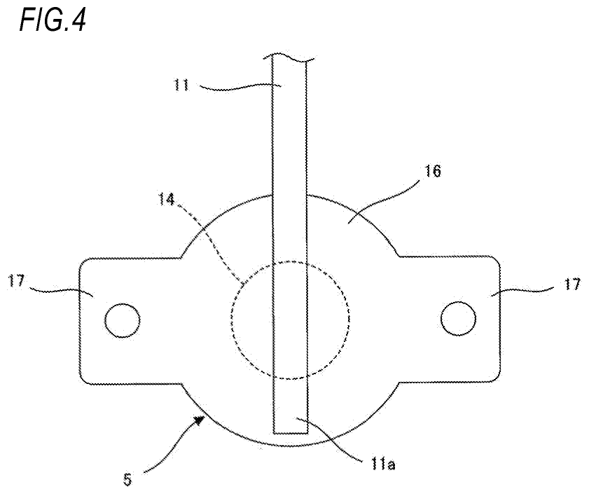

Preferably, as illustrated in FIG. 4, the main body 13 is fixed to the bracket 16 in a state where the vibrator 14 and the input portion 11 joined to the bracket 16 overlap each other in the excitation direction (third direction z) of the input portion 11. Thereby, attenuation of vibration in the bracket 16 can be prevented, and thus the end portion 11a of the input portion 11 can be vibrated efficiently. Preferably, the bracket 16 is made of material having a low vibration damping rate, for example, metal material. When the bracket 16 is made of metal material, the bracket 16 and the input portion 11 can be joined by welding, for example. However, the joining method of the bracket 16 and the input portion 11 is not limited to welding.

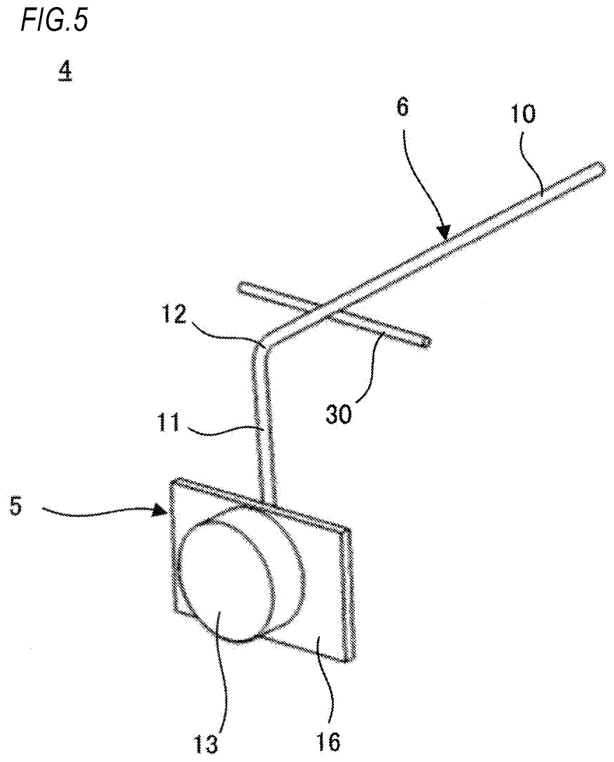

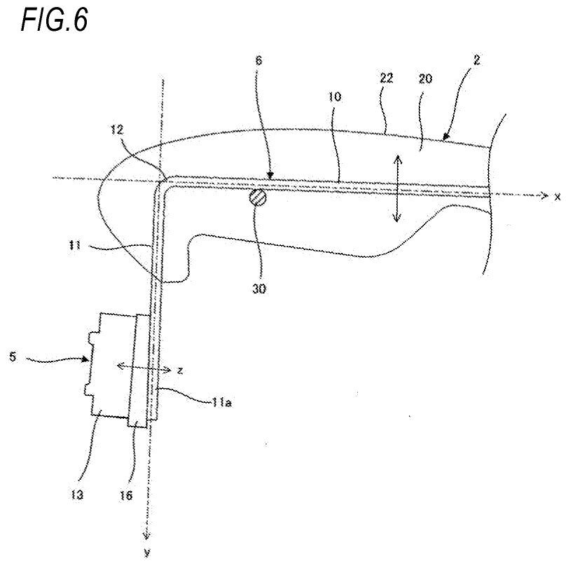

FIGS. 5 and 6 illustrate another example of the vibration generating device for explaining the embodiment of the invention.

The vibration generating device 4 illustrated in FIGS. 5 and 6 further includes a support member 30 which supports the vibration transmission member 6. The support member 30 is embedded in the cushion pad 20 similarly to the vibration transmission member 6. The support member 30 extends in a seat width direction (fourth direction), is disposed to intersect the operation portion 10, and supports the operation portion 10.

As described above, when the vibration transmission member 6 is vibrated by the vibration device 5, the input portion 11 vibrates in the seat front-rear direction and the operation portion 10 vibrates in the seat vertical direction. Therefore, the vibration transmission member 6 oscillates around an axis extending in the seat width direction as a whole. The support member 30 extending in the seat width direction becomes an oscillation axis of the vibration transmission member 6 and the oscillation axis of the vibration transmission member 6 is clarified. Thereby, the vibration of the operation portion 10 is also clarified in the seat vertical direction and the transmission of vibration to the seated person is further improved.

Preferably, the support member 30 is integrally joined to the vibration transmission member 6 at the intersection of the support member 30 and the vibration transmission member 6. The striking sound which occurs when the support member 30 and the vibration transmission member 6 repeatedly come into contact with the vibration can be prevented. The joining method of the support member 30 and the vibration transmission member 6 is not particularly limited. For example, when the support member 30 is made of a metal material, it may be joined by welding. The support member 30 and the vibration transmission member 6 may be joined by adhesion.

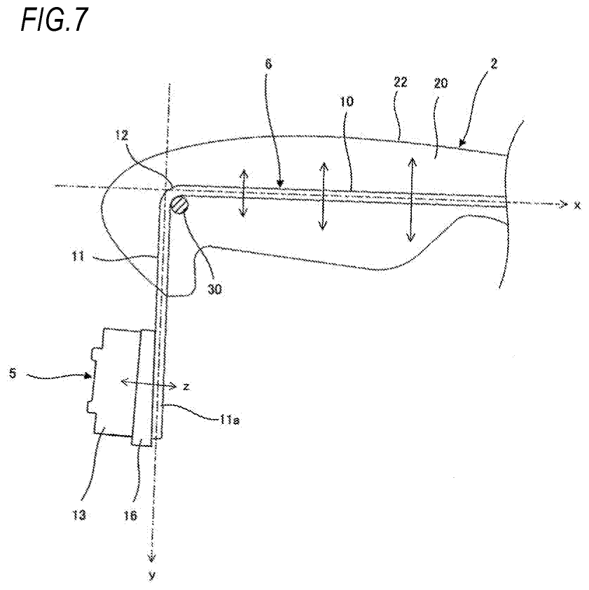

As illustrated in FIG. 7, the support member 30 may be arranged to intersect with the bent portion 12 and support the bent portion 12. In oscillation of the vibration transmission member 6 with the support member 30 as the axis, the vibration amplitude of each part of the operation portion 10 is related to the distance between each part of the operation portion 10 and the support member 30 and the vibration amplitude increases as the distance increases. By placing the support member 30 across the bent portion 12, the distance between each part of the operation portion 10 and the support member 30 is increased overall and the vibration amplitude of each part of the operation portion 10 is increased over the entire length of the operation portion 10. As a result, vibration transmission to a seated person is further improved.

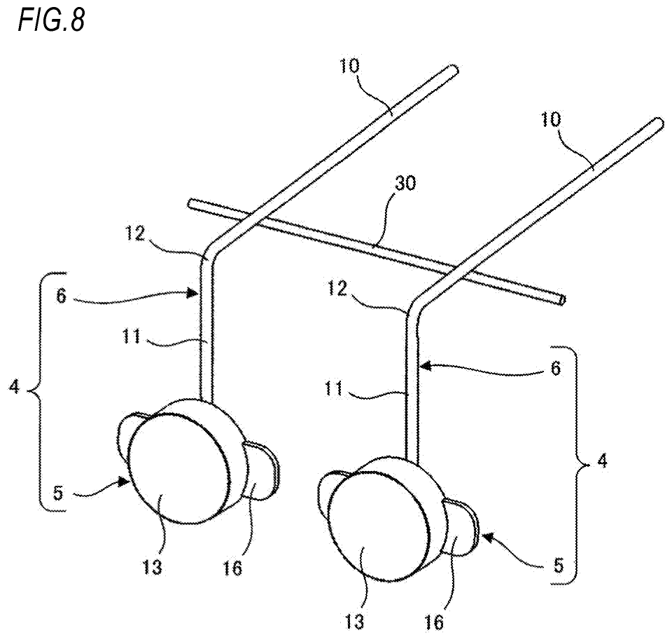

As illustrated in FIG. 8, when two vibration generating devices 4 and 4 are arranged adjacent to each other while being spaced apart in the seat width direction (fourth direction), the support member 30 may be commonly used for the two vibration generating devices 4 and 4. In other words, the support member 30 may be provided across the two vibration transmission members 6 and 6. The positioning of the two vibration generating devices 4 and 4 in the seat width direction is facilitated.

When the support member 30 is provided across the two vibration transmission members 6 and 6, the support member 30 is preferably made of material having a large vibration damping rate, for example, resin material. Thereby, the two vibration transmission members 6 and 6 are vibration-insulated from each other and can be suitably used for the lane departure prevention support system described above.

Hereinbefore, the invention has been described by taking the seat 1 installed in a vehicle such as an automobile as an example, but the invention is also applicable to a seat for a vehicle other than a vehicle such as a ship or an aircraft.

As described above, the vehicle seat disclosed in the specification includes a cushion pad, a vibration transmission member which has a wire shape and is embedded in the cushion pad, and a vibration device which vibrates the vibration transmission member, where the vibration transmission member includes a bent portion, an operation portion provided on one end side with respect to the bent portion and extending in a first direction along a seated person support surface of the cushion pad, and an input portion provided on the other end side with respect to the bent portion and extending in a second direction intersecting the seated person support surface, and the vibration device vibrates the input portion in a third direction intersecting the second direction in a plane defined by the first direction and the second direction.

The vehicle seat disclosed in the specification includes a support member which is embedded in the cushion pad and supports the vibration transmission member, where the support member extends in a fourth direction perpendicular to the plane, is arranged to intersect the bent portion or the operation portion, and supports the bent portion or the operation portion.

In the vehicle seat disclosed in the specification, the support member is arranged to intersect the bent portion and supports the bent portion.

In the vehicle seat disclosed in the specification, the vibration transmission member and the support member are joined together at an intersection.

The vehicle seat disclosed in the specification includes two vibration transmission members and two vibration devices each of which is provided for each vibration transmission member, where the two vibration transmission members are spaced apart in the fourth direction and the support member is provided across the two vibration transmission members.

In the vehicle seat disclosed in the specification, the support member is made of resin material and makes the two vibration transmission members vibration-insulated from each other.

In the vehicle seat disclosed in the specification, the vibration device includes a main body including a vibrator and a bracket for attaching the main body to the input portion in a state where the vibrator and the input portion overlap in the third direction.

In the vehicle seat disclosed in the specification, the bracket is made of metal material.

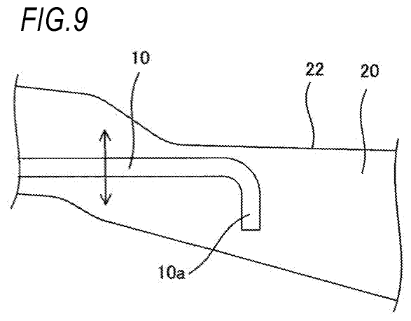

FIG. 9 illustrates an enlarged tip end portion of the operation portion 10.

A tip end portion 10a of the operation portion 10 is bent downward of the seat that is spaced from the seated person support surface 22 in the seat vertical direction which is the vibration direction of the operation portion 10. Although the edge is easily perceived by a seated person, an edge at a tip of the tip end portion 10a is directed to the lower surface of the cushion pad 20 on an opposite side of the seated person support surface 22, and thus the feeling of irritation given to a seated person is reduced. The tip end portion 10a bent in the seat vertical direction does not resist the vibration in the seat vertical direction of the operation portion 10 and the attenuation of vibration caused by the bent tip end portion 10a is prevented. As a result, vibration can be finely transmitted to a seated person.

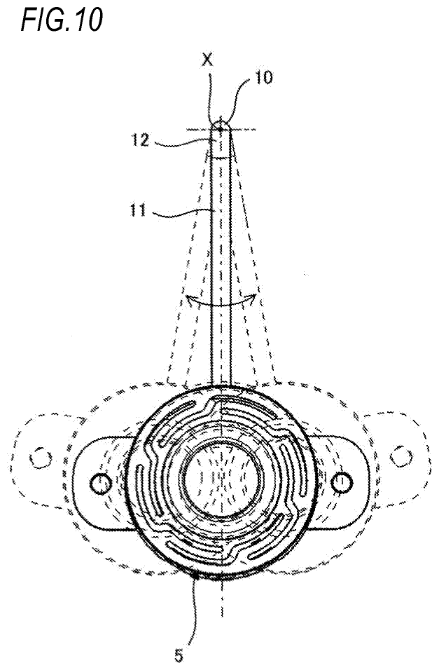

On the other hand, the tip end portion 10a bent in the seat vertical direction is resistant to an axial movement of the operation portion 10 extending in the seat front-rear direction. For example, when an impact in the seat front-rear direction acts on the vibration transmission member 6, the tip end portion 10a is caught by the cushion pad 20, and thus the displacement of the vibration transmission member 6 is prevented. As illustrated in FIG. 10, the end portion 10a bent in the seat vertical direction is also resistant to rotation around a central axis X of the operation portion 10. Therefore, for example, when an impact in the seat width direction acts on the vibration transmission member 6, the tip end portion 10a is caught by the cushion pad 20, and thus the inclination of the vibration transmission member 6 is prevented. Thus, the fixing strength of the vibration transmission member 6 is increased by the end portion 10a bent in the seat vertical direction.

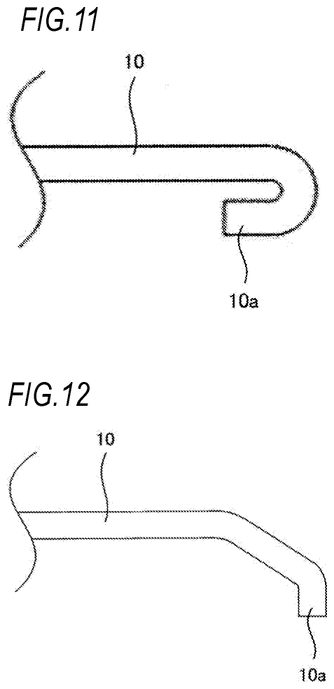

The tip end portion 10a of the operation portion 10 only needs to be bent downward of the seat. For example, as illustrated in FIG. 11, the tip end portion 10a may be folded back and formed in a J shape or may be bent at a plurality of locations as illustrated in FIG. 12. When the tip end portion 10a is bent at a plurality of locations, the tip end portion 10a can be formed in accordance with the shape of the seated person support surface 22 of the cushion pad 20, and thus the degree of freedom of arrangement of the operation portion 10 can be increased.

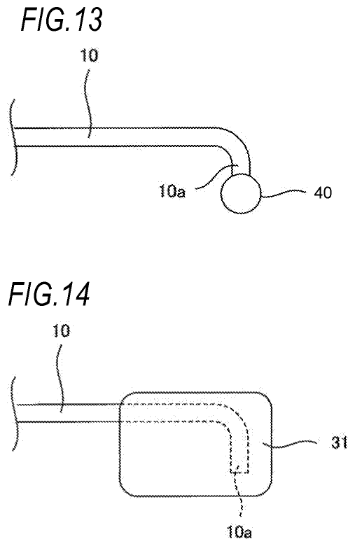

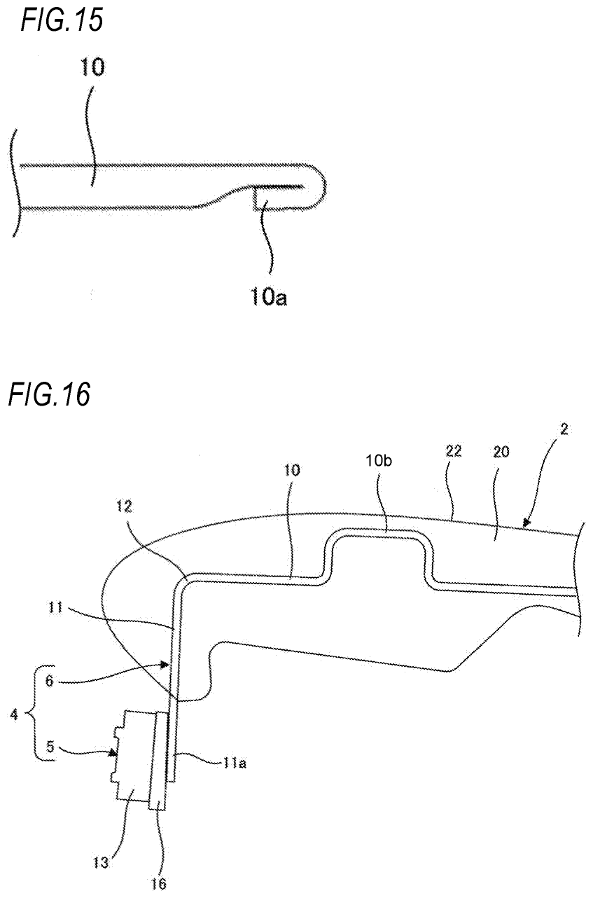

The tip end portion 10a of the operation portion 10 may be subjected to terminal processing for hiding the edge of the tip. In the terminal processing, for example, as illustrated in FIG. 13, a sphere 40 made of a metal material may be welded to the tip end portion 10a or a cap 31 may be put on the tip end portion 10a as illustrated in FIG. 14, or the tip end portion 10a may be folded back and flattened as illustrated in FIG. 15.

FIG. 16 illustrates a modification example of the vibration transmission member 6 and the operation portion 10 includes a convex portion 10b. The convex portion 10b is formed by bending a part of the operation portion 10 in the seat vertical direction, which is the vibration direction of the operation portion 10, and the convex portion 10b is disposed closer to the seated person support surface 22 of the cushion pad 20 than the other portions of the operation portion 10 except the convex portion 10b. Therefore, the vibration in the convex portion 10b is relatively easily perceived by a seated person. The operation portion 10 may include a recess portion which is separated from the seated person support surface 22 of the cushion pad 20 instead of or in addition to the protrusion 10b. The vibration in the recess is relatively less perceived by a seated person. By appropriately combining the convex portion 10b and the recess portion, the layout of the vibration transmission range on the seated person support surface 22 can be variously changed.

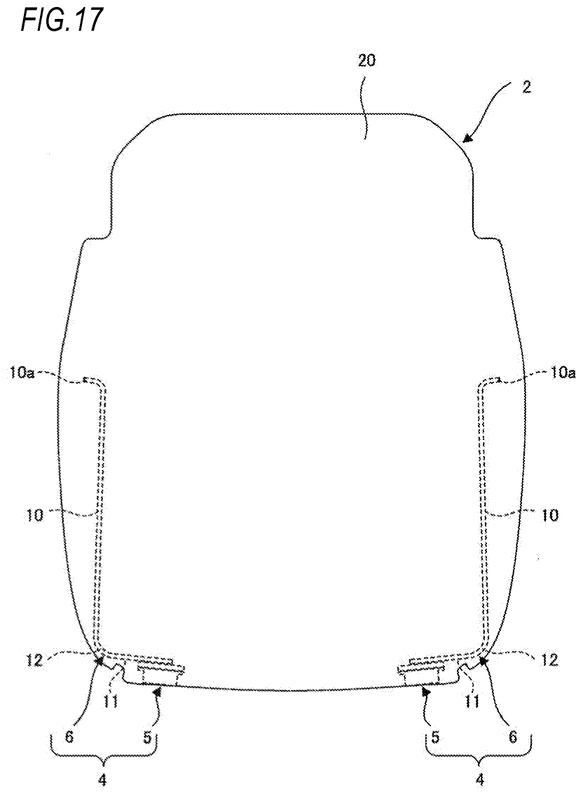

So far, the vibration generating device 4 has been described as being installed in the center of the seat cushion 2 in the seat width direction and the operation portion 10 vibrates in the seat vertical direction. However, as illustrated in FIG. 17, the vibration generating devices 4 may be installed on both end portions of the seat cushion 2 in the seat width direction, that is, on side support portions which support the side of the thighs of a seated person. When the vibration generating device 4 is installed on the side support portion of the seat cushion 2, the operation portion 10 vibrates in the seat width direction intersecting with the seated person support surface in the side support portion and the tip end portion 10a of the operation portion 10 is bent outwardly in the seat width direction and away from the seated person support surface.

Hereinbefore, the invention has been described by taking the seat 1 installed in a vehicle such as an automobile as an example, but the invention is also applicable to a seat for a vehicle other than an automobile such as a ship or an aircraft.

As described above, the vehicle seat disclosed in the specification includes a cushion pad, a vibration transmission member which has a wire shape and is embedded in the cushion pad, and a vibration device which vibrates the vibration transmission member, where the vibration transmission member includes an operation portion which extends along a seated person support surface of the cushion pad and vibrates in a direction intersecting the seated person support surface and a tip end portion of the operation portion is bent in a vibration direction of the operation portion and in a direction away from the seated person support surface.

In the vehicle seat disclosed in the specification, the tip end portion of the operation portion is subjected to terminal processing for hiding an edge.

In the vehicle seat disclosed in the specification, the operation portion is bent in the vibration direction of the operation portion and includes a convex portion approaching the seated person support surface and/or a recess portion spaced from the seated person support surface.

In the vehicle seat disclosed in the specification, the vibration transmission member includes a bent portion and an input portion and the operation portion is provided on one end side with respect to the bent portion, and further the input portion is provided on the other end side with respect to the bent portion and extends in a direction intersecting the seated person support surface, and still further the vibration device vibrates the input portion in a direction intersecting with an extending direction of the input portion in a plane defined by an extending direction of the operation portion and the extending direction of the input portion.

What is claimed is:

1. A vehicle seat, comprising:
a cushion pad;
a vibration transmission member which has a wire shape and is embedded in the cushion pad; and
a vibration device configured to vibrate the vibration transmission member, wherein:
the vibration transmission member includes:
a bent portion;
an operation portion provided on one end side with respect to the bent portion and extending in a first direction along a seated person support surface of the cushion pad; and
an input portion provided on the other end side with respect to the bent portion and extending in a second direction intersecting the seated person support surface; and
the vibration device vibrates the input portion in a third direction intersecting the second direction in a plane defined by the first direction and the second direction.

2. The vehicle seat according to claim 1, further comprising:
a support member which is embedded in the cushion pad and supports the vibration transmission member, wherein
the support member extends in a fourth direction perpendicular to the plane, is arranged to intersect the bent portion or the operation portion, and supports the bent portion or the operation portion.

3. The vehicle seat according to claim 2, wherein
the support member is arranged to intersect the bent portion and supports the bent portion.

4. The vehicle seat according to claim 2, wherein
the vibration transmission member and the support member are joined together at an intersection.

5. The vehicle seat according to claim 4, further comprising:
two vibration transmission members and two vibration devices each of which is provided for each vibration transmission member, wherein:
the two vibration transmission members are spaced apart in the fourth direction; and
the support member is provided across the two vibration transmission members.

6. The vehicle seat according to claim 5, wherein
the support member is made of resin material and makes the two vibration transmission members vibration-insulated from each other.

7. The vehicle seat according to claim 1, wherein
the vibration device includes: a main body including a vibrator; and a bracket configured to attach the main body to the input portion in a state where the vibrator and the input portion overlap in the third direction.

8. The vehicle seat according to claim 7, wherein
the bracket is made of metal material.

9. A vehicle seat, comprising:
a cushion pad;
a vibration transmission member which has a wire shape and is embedded in the cushion pad; and
a vibration device configured to vibrate the vibration transmission member, wherein:
the vibration transmission member includes an operation portion which extends along a seated person support surface of the cushion pad and vibrates in a direction intersecting the seated person support surface; and
a tip end portion of the operation portion is bent in a vibration direction of the operation portion and in a direction away from the seated person support surface.

10. The vehicle seat according to claim 9, wherein
the tip end portion of the operation portion is subjected to terminal processing for hiding an edge.

11. The vehicle seat according to claim 9, wherein
the operation portion is bent in the vibration direction of the operation portion and includes a convex portion approaching the seated person support surface and/or a recess portion spaced from the seated person support surface.

12. The vehicle seat according to claim 9, wherein:
the vibration transmission member includes a bent portion and an input portion;
the operation portion is provided on one end side with respect to the bent portion;
the input portion is provided on the other end side with respect to the bent portion and extends in a direction intersecting the seated person support surface; and
the vibration device vibrates the input portion in a direction intersecting with an extending direction of the input portion in a plane defined by an extending direction of the operation portion and the extending direction of the input portion.
